(19) United States
(12) Patent Application Publication
(10) Pub. No.: US 2025/0200384 A1
(43) Pub. Date: Jun. 19, 2025

(54) SECURE GLOBAL MODEL CALCULATION APPARATUS, LOCAL MODEL REGISTERING METHOD, AND PROGRAM

(71) Applicant: NIPPON TELEGRAPH AND TELEPHONE CORPORATION, Tokyo (JP)

(72) Inventors: Iifan TYOU, Tokyo (JP); Gembu MOROHASHI, Tokyo (JP); Takumi FUKAMI, Tokyo (JP)

(73) Assignee: NIPPON TELEGRAPH AND TELEPHONE CORPORATION, Tokyo (JP)

(21) Appl. No.: 18/849,677

(22) PCT Filed: Mar. 31, 2022
(86) PCT No.: PCT/JP2022/016505

§ 371 Date: Sep. 23, 2024

(51) Int. Cl. G06N 3/098

(52) U.S. Cl. CPC G06N 3/098

(57) ABSTRACT

A technique for efficiently registering local models in a local model management table used when a global model is computed from local models in federated learning is provided. A secure global model computation device in a federated learning system including M local model training devices for training local models using training data and a secure global model computation system composed of N secure global model computation devices for secure computation of a global model from M local models includes a parameter share registration unit that receives shares of parameters of an m-th local model trained by an m-th local model training device (where m satisfies 1≤m≤M)) as an input and register the shares of the parameters of the m-th local model in a local model management table using K records having a set (m, k) of identifiers and shares of parameters of a k-th layer (1≤k≤K) of the m-th local model as one record.

### TECHNICAL FIELD

The present invention relates to a federated learning technique, and particularly, to a technique for efficiently registering a local model in a local model management table used to compute a global model from local models.

### BACKGROUND ART

As a technique for performing learning without aggregating training data into one device, there is a federated learning technique. As a federated learning technique, there is FedAVG described in Non Patent Literature 1, for example.

FIG. 1 is a diagram showing a basic configuration of a federated learning system. The federated learning system 90 includes M (M is an integer of 2 or more) local model training devices 100₁, . . . , 100ₘ and a global model computation device 900. The basic operation of the federated learning system 90 is as follows. The local model training devices 100₁, . . . , 100ₘ train local models using training data recorded in their own recording units. After completion of training, the local model training devices 100₁, . . . , 100ₘ transmit the local models to the global model computation device 900 via a network 800. The global model computation device 900 computes a global model using the received local models. After computation is completed, the global model computation device 900 transmits the global model to the local model training devices 100₁, . . . , 100ₘ via the network 800. The local model training devices 100₁, . . . , 100ₘ train local models again using the received global model. By repeating this operation, the federated learning system 90 advances model training. In this case, the global model computation device 900 manages parameters of local models using a local model management table as shown in FIG. 2, for example. Here, a local model is a neural network composed of K layers, and the local model management table is a table including attributes having identifiers k (1≤k≤K, where K is an integer of 2 or more) for identifying layers as attribute values and attributes having parameters of an m-th local model (1≤m≤M) that is a local model trained by a local model training device 100ₘ as attribute values. The example of FIG. 2 shows that parameters of the first layer of the first local model are (0.11, . . . ,0.2), parameters of the second layer are (0.5, . . . , 0.2), . . . , and parameters of the K-th layer are (0.7, . . . , 0.9). Note that an SQL database, for example, can be used for management of parameters of local models.

When the federated learning technique is used, since training data is not taken outside of a local model training device, anxiety about taking the data out can be eliminated, and at the same time, high speed can be attained through parallel learning. However, if parameters of a model that is being trained are traced and leak from the process of communication between the local model training devices 100₁, . . . , 100_{M} and the global model computation device 900, for example, there is a risk of training data being inferred. In order to avoid such a risk, using secure computation for computation of a global model can be considered.

Secure computation is a method of obtaining results of a designated arithmetic operation without restoring encrypted numerical values (refer to Reference Non Patent Literature 1, for example). In the method of Reference Non Patent Literature 1, encryption for distributing a plurality of pieces of information that can be used to restore numerical values to three secure computation devices can be performed to maintain a state in which results of addition/subtraction, constant summation, multiplication, constant multiplication, logical operations (negation, logical product, logical sum, and exclusive logical sum), and data format conversion (integer, binary) have been distributed to the three secure computation devices without restoring numerical values, that is, an encrypted state. In general, the number of distributions is not limited to 3 and can be N (N is an integer of 3 or more), and a protocol for realizing secure computation by cooperative computation by N secure computation devices is called a multiparty protocol.

(Reference Non Patent Literature 1: Koji Chida, Koki Hamada, Dai Igarashi, and Katsumi Takahashi, “Reconsideration of Lightweight Verifiable 3-Party Concealment Function Computation,” In CSS, 2010.)

### CITATION LIST

### Non Patent Literature

[NPL 1] McMahan, B., E. Moore, D. Ramage, et al., “Communication-efficient learning of deep networks from decentralized data,” In Artificial Intelligence and Statistics, pp. 1273-1282, 2017.

### SUMMARY OF INVENTION

### Technical Problem

However, if a global model is computed by managing parameters of local models using a local model management table having the same structure as that of FIG. 2, the table is recreated due to a combination of a parameter share registration method and a database at the time of registering shares of parameters of local models in the local model management table, and thus it takes much time to compute a global model.

Accordingly, an object of the present invention is to provide a technique for efficiently registering local models in a local model management table used when a global model is computed from local models in federated learning.

### Solution to Problem

One aspect of the present invention is a secure global model computation device in a federated learning system including M local model training devices for training local models using training data and a secure global model computation system composed of N secure global model computation devices for secure computation of a global model from M local models, wherein M and K are integers of 2 or more and N is an integer of 3 or more, a local model is defined as a neural network composed of K layers, and a local model management table is defined as a table including an attribute having a set (m, k) (1≤m≤M, 1≤k≤K) of an identifier m for identifying a local model and an identifier k for identifying a layer as an attribute value and an attribute having shares of parameters of the local model as an attribute value, the secure global model computation device including: a transmission/reception unit configured to receive shares of parameters of a local model (hereinafter referred to as an m-th local model) trained by one local model training device (hereinafter referred to as an m-th local model training device (where m satisfies 1≤m≤M)) among the M local model training devices; and a parameter share registration unit configured to register the shares of the parameters of the m-th local model in a local model management table using K records having a set (m, k) of identifiers and shares of parameters of a k-th layer (1≤k≤K) of the m-th local model as one record.

One aspect of the present invention is a secure global model computation device in a federated learning system including M local model training devices for training local models using training data and a secure global model computation system composed of N secure global model computation devices for secure computation of a global model from M local models, wherein M and K are integers of 2 or more and N is an integer of 3 or more, a local model is defined as a model represented using K vectors, and a local model management table is defined as a table including an attribute having a set (m, k) (1≤m≤M, 1≤k≤K) of an identifier m for identifying a local model and an identifier k for identifying a vector constituting the local model as an attribute value and an attribute having shares of parameters of the local model as an attribute value, the secure global model computation device including: a transmission/reception unit configured to receive shares of parameters of a local model (hereinafter referred to as an m-th local model) trained by one local model training device (hereinafter referred to as an m-th local model training device, where m satisfies 1≤m≤M) among the M local model training devices; and a parameter share registration unit configured to register the shares of the parameters of the m-th local model in a local model management table using K records having a set (m, k) of identifiers and shares of parameters included in a k-th vector (1≤k≤K) of the m-th local model as one record.

### Advantageous Effects of Invention

According to the present invention, it is possible to efficiently register local models in the local model management table used when a global model is computed from local models in the federated learning.

### BRIEF DESCRIPTION OF DRAWINGS

FIG. 1 is a diagram showing a basic configuration of a federated learning system 90.

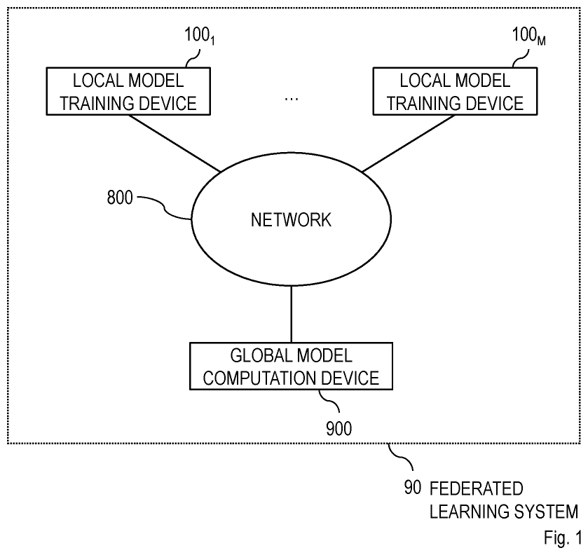

FIG. 2 is a diagram showing a structure of a conventional local model management table.

FIG. 3 is a diagram showing a structure of a local model management table of the present invention.

FIG. 4 is a block diagram showing a configuration of a federated learning system 10.

FIG. 5 is a block diagram showing a configuration of a local model training device 100ₘ.

FIG. 6 is a block diagram showing a configuration of a secure global model computation device 200ₙ.

FIG. 7 is a flowchart showing an operation of the local model training device 100ₘ.

FIG. 8 is a flowchart showing an operation of a secure global model computation system 20.

FIG. 9 is a diagram showing an example of a functional configuration of a computer that realizes each device in embodiments of the present invention.

### DESCRIPTION OF EMBODIMENTS

The following describes embodiments of the present invention in detail. Note that constituent elements having the same function will be denoted by the same reference numerals and redundant description thereof will be omitted.

A notation method used in this specification will be described before the embodiments are described.

^ (caret) denotes superscript. For example, x^{y^z} indicates that y^{z} is a superscript to x, and x_{y^z} indicates that y^{z} is a subscript to x. In addition, _ (underscore) indicates a subscript. For example, x^{y_z} indicates that y_{z} is a superscript to x, and x_{y_z} indicates that y_{z} is a subscript to x. Superscripts “^” and “˜” as in ^ x and ˜x for a certain character x would normally be written directly above “x,” but are written as ^x or ˜x here due to restrictions on notation in this specification.

### Technical Background

### Secure Computation

Secure computation in the present invention is constructed using a combination of arithmetic operations in existing secure computation. Arithmetic operations necessary for the secure computation include, for example, concealment, addition, subtraction, multiplication, division, logical operations (negation, logical product, logical sum, and exclusive logical sum), and comparison operations (=, <, >, ≤, and ≥). Several operations and their notation will be described below.

### Concealment

[[x]]is assumed to be a value obtained by concealing x by secret sharing (hereinafter referred to as a share of x). Any method can be used as a secret sharing method. For example, Shamir secret sharing on GF (2⁶¹-1) and replicated secret sharing on Z₂ can be used.

A plurality of secret sharing methods may be used in combination in one certain algorithm. In this case, it is assumed that they can be interconverted as appropriate.

Further, it is assumed that [[^{→}x]]=([[x₁]], . . . , [[x_{N}]]) for an N-dimensional vector ^{→}x=(x₁, . . . , X_{N}). That is, [[^{→}x]] is a vector having a share [[xₙ]]of an n-th element xₙ, of ^{→}x as an n-th element. Similarly, for an M×N matrix A=(a_{m,n}) (1≤m≤M , 1≤n≤N), [[A]] is assumed to be a matrix having a share [[a_{m,n}]] of an (m, n)-th element of A as an (m, n)-th element.

Note that x is referred to as plaintext of [[x]].

As a method of obtaining [[x]] from x (concealment) and a method of obtaining x from [[x]] (restoration), specifically, there are methods described in Reference Non Patent Literature 1 and Reference Non Patent Literature 2.

(Reference Non Patent Literature 2: Shamir, A, “How to share a secret,” Communications of the ACM, Vol. 22, No. 11, pp. 612-613, 1979.)

### Addition, Subtraction, Multiplication, and Division

Addition [[x]]+[[y]] according to secure computation has [[x]] and [[y]] as inputs and [[x+y]] as an output. Subtraction [[x]]−[[y]] according to secure computation has [[x]] and [[y]] as inputs and [[x−y]] as an output. Multiplication [[x]]×[[y]] (which may be represented as mul([[x]], [[y]])) according to secure computation has [[x]] and [[y]] as inputs and [[x×y]] as an output. Division [[x]]/[[y]] (which may be represented as div ([[x]], [[y]])) according to secure computation has [[x]] and [[y]] as inputs [[x/y]] as an output.

As specific methods of addition, subtraction, multiplication and division, there are methods described in Reference Non Patent Literature 3 and Reference Non Patent Literature 4.

(Reference non-patent literature 3: Ben-or, M., Goldwasser, S. and Wigderson, A., “Completeness theorems for non-cryptographic fault-tolerant distributed computation,” Proceedings of the twentieth annual ACM symposium on Theory of computing, ACM, pp. 1-10, 1988.)

(Reference non-patent literature 4: Gennaro, R., Rabin, M. O. and Rabin, T., “Simplied VSS and fast-track multiparty communications with applications to threshold cryptography,” Proceedings of the seventeenth annual ACM symposium on

Principles of distributed computing, ACM, pp. 101-111, 1998.)

### Logical Operations

Negation not [[x]] according to secure computation has [[x]] as an input and [[not(x)]] as an output. Logical product and ([[x]], [[y]]) according to secure computation has [[x]] and [[y]] as inputs and [[and(x, y)]] as an output. Logical sum or ([[x]], [[y]]) according to secure computation has [[x]] and [[y]] as inputs and [[or(x, y)]] as an output. Exclusive logical sum xor([[x]], [[y]]) according to secure computation has [[x]] and [[y]] as inputs and [[xor(x, y)]] as an output.

Note that logical operations can be easily constructed by combining addition, subtraction, multiplication, and division.

Comparison Operations

Equal sign decision=([[x]], [[y]]) (which may be represented as equal ([[x]], [[y]])) according to secure computation has [[x]] and [[y]] as inputs, [[1]] as an output when x=y, and [[0]] as an output in other cases. Comparison <([[x]], [[y]]) according to secure computation has [[x]] and [[y]] as inputs, [[1]] as an output when x<y, and [[0]] as an output in other cases. Comparison >([[x]], [[y]]) according to secure computation has [[x]] and [[y]] as inputs, [[1]] as an output when x>y, and [[0]] as an output in other cases. Comparison ≤([[x]], [[y]]) according to secure computation has [[x]] and [[y]] as inputs, [[1]] as an output when x≤y, and [[0]] as an output in other cases. Comparison ≥([[x]], [[y]]) according to secure computation has [[x]] and [[y]] as inputs, [[1]] as an output when x≥y, and [[0]] as an output in other cases.

Note that comparison operations can be easily constituted by combining logical operations.

### Local Model Management Table

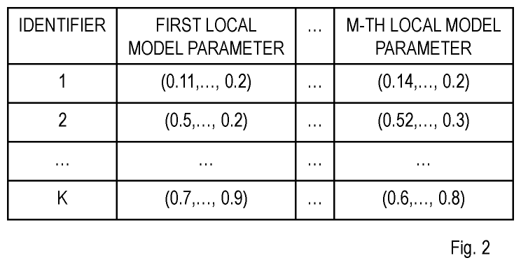

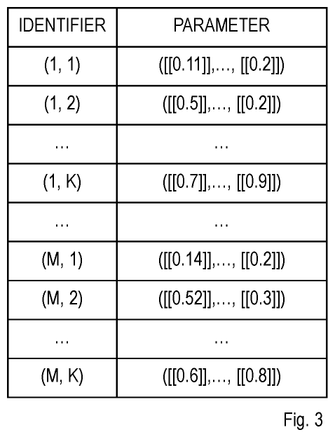

As described in [Technical Problem], it is very inefficient to compute a global model using the local model management table shown in FIG. 2. Therefore, in the present invention, a global model is computed using a local model management table as shown in FIG. 3. The local model management table in FIG. 3 is a table including an attribute (hereinafter referred to as identifier attribute) having a set (m, k) (1≤m≤M, 1≤k≤K, where M and K are integers of 2 or more) of an identifier m for identifying a local model and an identifier k for identifying a layer as an attribute value and an attribute (hereinafter referred to as parameter attribute) having shares of parameters as an attribute value, and a table composed of MK records. When the value of an identifier attribute is (m, k), the record of the local model management table in FIG. 3 indicate that the value of the corresponding parameter attribute is shares of parameters of the k-th layer of the m-th local model. When the local model management table shown in FIG. 3 is used, the table is not recreated when shares of parameters of local models are registered in the local model management table, and thus the amount of computations can be reduced and the speed of computation of a global model can be increased.

### First embodiment

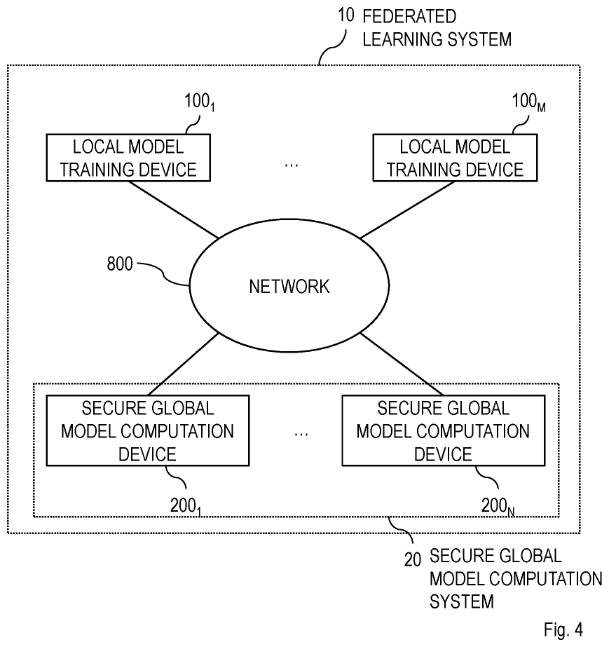

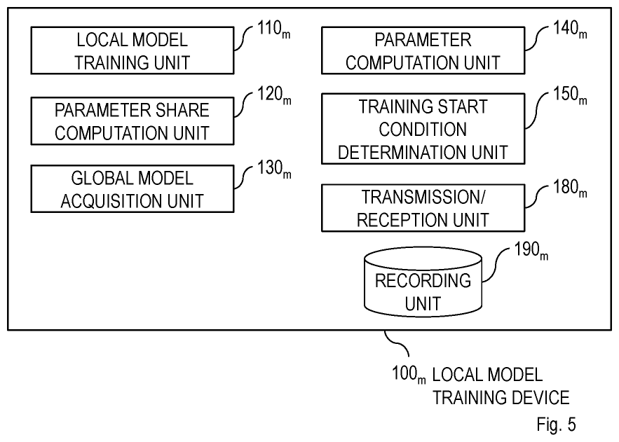

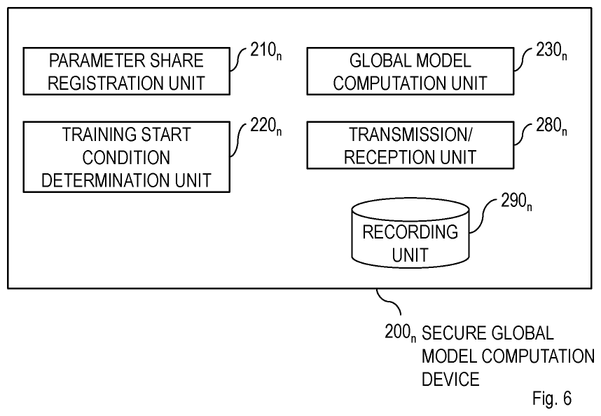

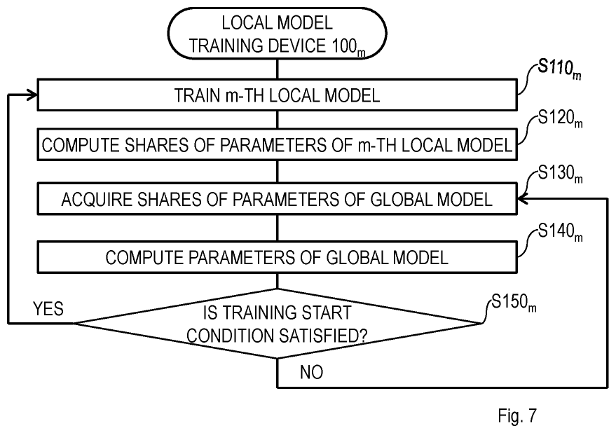

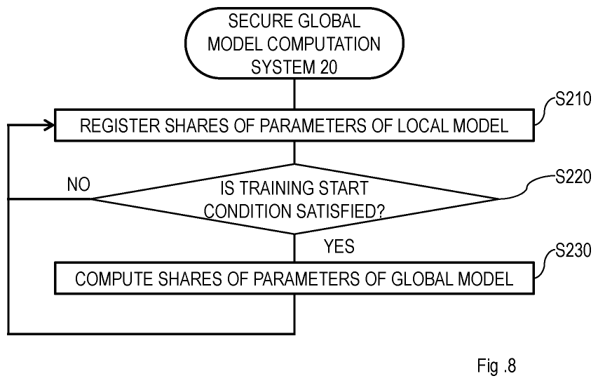

Hereinafter, a federated learning system 10 will be described with reference to FIGS. 4 to 8. FIG. 4 is a block diagram showing a configuration of the federated learning system 10. The federated learning system 10 includes M (M is an integer of 2 or more) local model training devices 100₁, . . . , 100_{M} and a secure global model computation system 20. The secure global model computation system 20 includes N (N is an integer of 3 or more) secure global model computation devices 200₁, . . . , 200_{N}. The local model training devices 100₁, . . . , 100ₘ are connected to a network 800 and can communicate with the secure global model computation system 20. The secure global model computation devices 200₁, . . . , 200_{N} are connected to the network 800 and can communicate with each other. The network 800 may be, for example, a communication network such as the Internet or a broadcast communication path. FIG. 5 is a block diagram showing a configuration of a local model training device 100ₘ (1≤m≤M). FIG. 6 is a block diagram showing a configuration of a secure global model computation device 200ₙ (1≤n≤N). FIG. 7 is a flowchart showing an operation of the local model training device 100ₘ. FIG. 8 is a flowchart showing an operation of the secure global model computation system 20.

As shown in FIG. 5, the local model training device 100ₘ includes a local model training unit 110ₘ, a parameter share computation unit 120ₘ, a global model acquisition unit 130ₘ, a parameter computation unit 140ₘ, a training start condition determination unit 150ₘ, a transmission/reception unit 180ₘ, and a recording unit 190ₘ. The recording unit 190ₘ is a component that records information necessary for processing of the local model training device 100ₘ. The recording unit 190ₘ records, for example, training data and parameters of local models. Here, a local model is a neural network composed of K (K is an integer of 2 or more) layers as described above. Note that training data is updated as appropriate.

As shown in FIG. 6, the secure global model computation device 200, includes a parameter share registration unit 210ₙ, a training start condition determination unit 220ₙ, a global model computation unit 230ₙ, a transmission/reception unit 280ₙ, and a recording unit 290ₙ. Each component of the secure global model computation device 200ₙ excluding the parameter share registration unit 210ₙ, the transmission/reception unit 280ₙ, and the recording unit 290ₙ, is configured to be able to execute arithmetic operations required to realize the function of each component among arithmetic operations required for computation of a global model, such as concealment, addition, subtraction, multiplication, division, logical operation, and comparison operations, for example. Specific functional configurations for realizing individual operations in the present invention are sufficient to be configurations capable of executing existing algorithms, and since these are conventional configurations, detailed description thereof will be omitted. Further, the recording unit 290ₙ is a component that records information necessary for processing of the secure global model computation device 200ₙ. The recording unit 290ₙ records, for example, the local model management table and shares of parameters of global models. Here, the local model management table is a table including an attribute having a set (m, k) (1≤m≤M, 1≤k≤K) of an identifier m for identifying a local model and an identifier k for identifying a layer as an attribute value and an attribute having shares of parameters of local models as an attribute value, as described above. Note that the secure global model computation device 200, is different from the local model training device 100ₘ in that training data is not recorded therein. Further, a global model is a neural network composed of K layers having the same structure as the local model.

The secure global model computation system 20 realizes secure computation of a global model which is a multiparty protocol according to cooperative computation by N secure global model computation devices 200ₙ. Therefore, training start condition determination means 220 (not shown) of the secure global model computation system 20 is composed of training start condition determination units 220₁, . . . , 220_{N}, and global model computation means 230 (not shown) is composed of global model computation units 230₁, . . . , 230_{N}.

Hereinafter, an operation of the local model training device 100ₘ will be described with reference to FIG. 7. The local model training device 100ₘ is referred to as an m-th local model training device 100, and a local model trained by the local model training device 100ₘ is referred to as an m-th local model. That is, the m-th local model training device 100 trains the m-th local model using training data.

In S110ₘ, the local model training unit 110ₘ trains the m-th local model using training data recorded in the recording unit 190ₘ. In the first training of the m-th local model, the local model training unit 110ₘ may set initial values of parameters of the m-th local model using initial values recorded in advance in the recording unit 190ₘ or may set the initial values of the parameters of the m-th local model using initial values generated using random numbers. In the second and subsequent training of the m-th local model, the local model training unit 110ₘ sets initial values of the parameter of the m-th local model using a global model acquired in S130ₘ which will be described later.

In S120ₘ, the parameter share computation unit 120ₘ computes shares of the parameters of the m-th local model from the parameters of the m-th local model trained in S110ₘ. When the computation is finished, the parameter share computation unit 120ₘ transmits the shares of the parameters of the m-th local model to the secure global model computation devices 200₁, . . . , 200_{N} using the transmission/reception unit 180ₘ.

In S130ₘ, the global model acquisition unit 130ₘ acquires shares of parameters of the global model from the secure global model computation devices 200₁, . . . , 200_{N} using the transmission/reception unit 180ₘ after the end of processing of S120ₘ or after the elapse of a predetermined time from the end of processing of S150ₘ.

In S140ₘ, the parameter computation unit 140ₘ computes parameters of the global model from the shares of the parameters of the global model acquired in S130ₘ. The parameter computation unit 140ₘ records the computed parameters of the global model in the recording unit 190ₘ. Note that, in the recording unit 190ₘ, at least two sets of the parameters of the global model, that is, the parameters of the global model obtained through the current computation and the parameters of the global model obtained through the previous computation are recorded.

In S150ₘ, the training start condition determination unit 150ₘ compares the parameters of the global model computed in S140ₘ with the parameters of the global model obtained in the previous computation, executes processing of S110ₘ upon determining that a training start condition is satisfied in a case in which the two sets of the parameters of the global model are different, and returns to processing of S130ₘ upon determining that the training start condition is not satisfied in other cases.

Hereinafter, the operation of the secure global model computation system 20 will be described with reference to FIG. 8. Here, the secure global model computation system 20 performs secure computation of a global model from M local models.

In S210, the parameter share registration unit 210, of the secure global model computation device 200ₙ (1≤n≤N) takes the shares of the parameters of the m-th local model trained by the m-th local model training device 100 received using the transmission/reception unit 280, as inputs and registers the shares of the parameters of the m-th local model in the local model management table using K records having a set (m, k) of identifiers and shares of parameters of a k-th layer (1≤k≤K) of the m-th local model as one record.

In S220, the training start condition determination means 220 executes processing of S230 upon determining that a training start condition is satisfied in a case in which the number of newly registered local models exceeds a predetermined value (the value is 1 or more and M or less), or is equal to or greater than the predetermined value after the previous global model computation, and returns to processing of S210 upon determining that the training start condition is not satisfied in other cases.

In S230, the global model computation means 230 computes shares of parameters of the global model using the shares of the parameters of the local models managed by the local model management table. The global model computation means 230 sets an average of shares of corresponding parameters from the first local model to the M-th local model as the shares of parameters of the global model, for example. Note that processing speed can be increased by representing shares of parameters of each model using a vector and performing various operations.

### MODIFIED EXAMPLES

Although a local model is described as a neural network composed of K layers in the first embodiment, a local model may be a model represented using K vectors, in general. In this case, the local model management table is a table including an attribute having a set (m, k) (1≤m≤M, 1≤k≤K) of an identifier m for identifying a local model and an identifier k for identifying a vector constituting the local model as an attribute value and an attribute having shares of parameters of the local model as an attribute value. Further, in S210, the parameter share registration unit 210, of the secure global model computation device 200ₙ (1≤n≤N) takes the shares of the parameters of the m-th local model trained by the m-th local model training device 100 received using the transmission/reception unit 280ₙ, as inputs and registers the shares of the parameters of the m-th local model using K records having a set (m, k) of identifiers and shares of parameters included in a k-th vector (1≤k≤K) of the m-th local model as one record.

According to the embodiment of the present invention, it is possible to efficiently register local models in the local model management table used when a global model is computed from local models in federated learning.

### Additional Note

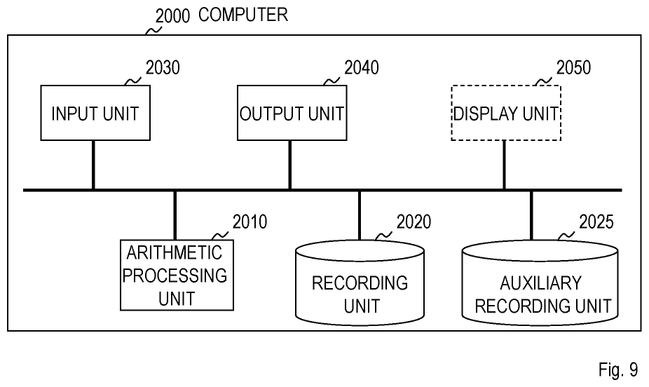

The processing of each unit of each device described above may be implemented by a computer, and in this case, the processing details of the functions that each device should have are described by a program. In addition, various types of processing functions in each device described above are realized on a computer by causing this program to be read by a recording unit 2020 of a computer 2000 shown in FIG. 9 and operating an arithmetic processing unit 2010, an input unit 2030, an output unit 2040, an auxiliary recording unit 2025, and the like.

Each device of the present invention includes, as a single hardware entity, for example, an input unit to which a signal can be input from the outside of the hardware entity, an output unit through which a signal can be output to the outside of the hardware entity, a communication unit to which a communication device (for example, a communication cable) capable of communicating with the outside of the hardware entity can be connected, a CPU (Central Processing Unit, which may include a cache memory, a register, or the like) serving as an arithmetic processing unit, a RAM and a ROM serving as memories, an external storage device serving as a hard disk, and a bus that connects the input unit, the output unit, the communication unit, the CPU, the RAM, the ROM, and the external storage device such that data can be exchanged therebetween. As necessary, a device (drive) capable of reading/writing data from/to a recording medium such as a CD-ROM may be provided in the hardware entity. An example of a physical entity including such hardware resources is a general-purpose computer.

The external storage device of the hardware entity stores programs necessary for realizing the functions described above, data necessary for processing the programs, and the like (not limited to the external storage device, for example, the program may be stored in a ROM which is a read-only storage device). In addition, data and the like obtained by processing of these programs are appropriately stored in the RAM, the external storage device, or the like.

In the hardware entity, each program stored in the external storage device (or the ROM or the like) and data necessary for processing each program are read into a memory as necessary, and are appropriately interpreted, executed, and processed by the CPU. As a result, the CPU realizes a predetermined function (each component represented by the aforementioned unit, . . . means, or the like). That is, each component of the embodiment of the present invention may be configured as processing circuitry.

As described above, when the processing function in the hardware entity (the device according to the present invention) described in the above-described embodiments is implemented by the computer, details of processing of the function included in the hardware entity is written by the program. Then, by executing this program on the computer, the processing function in the above-described hardware entity is implemented on the computer.

A program describing the details of processing can be recorded on a computer-readable recording medium. The computer-readable recording medium is, for example, a non-transitory recording medium, and specifically a magnetic recording device, an optical disc, or the like.

Further, the program is distributed, for example, by sales, transfer, or lending of a portable recording medium such as a DVD or a CD-ROM on which the program is recorded. In addition, the distribution of the program may be performed by storing the program in advance in a storage device of a server computer and transferring the program from the server computer to another computer via a network.

A computer executing such a program is configured to, for example, first, temporarily store a program recorded on a portable recording medium or a program transferred from a server computer in an auxiliary recording unit 2025 which is its own non-transitory storage device. When executing the processing, the computer reads the program stored in the auxiliary recording unit 2025 which is its own non-transitory storage device into the recording unit 2020, and executes the processing according to the read program. As another embodiment of the program, the computer may directly read the program from the portable recording medium into the recording unit 2020 and execute processing according to the program. Each time the program is transferred from the server computer to the computer, the processing according to the received program may be executed sequentially. In addition, the processing may be executed by means of a so-called ASP (Application Service Provider) type service which does not transfer a program from the server computer to the computer and implements processing functions only by execution instructions and acquisition of the results. It is assumed that the program in this embodiment includes equivalent which is information to be provided for processing by an electronic computer and which is equivalent to a program (e.g., data that is not a direct command to the computer but has the property of defining the processing of the computer).

In addition, although the present device is configured by executing a predetermined program on the computer in this form, at least a part of details of processing may be implemented by hardware.

The present invention is not limited to the above-described embodiment, and appropriate changes can be made without departing from the spirit of the present invention.

1. A secure global model computation device in a federated learning system including M local model training devices for training local models using training data and a secure global model computation system composed of N secure global model computation devices for secure computation of a global model from M local models,
wherein M and K are integers of 2 or more and N is an integer of 3 or more, a local model is defined as a neural network composed of K layers, and a local model management table is defined as a table including an attribute having a set (m, k) (1≤m≤M, 1≤k≤K) of an identifier m for identifying a local model and an identifier k for identifying a layer as an attribute value and an attribute having shares of parameters of the local model as an attribute value, the secure global model computation device comprising:
a transmission/reception circuitry configured to receive shares of parameters of a local model (hereinafter referred to as an m-th local model) trained by one local model training device (hereinafter referred to as an m-th local model training device (where m satisfies 1≤m≤M)) among the M local model training devices; and
a parameter share registration circuitry configured to register the shares of the parameters of the m-th local model in a local model management table using K records having a set (m, k) of identifiers and shares of parameters of a k-th layer (1≤k≤K) of the m-th local model as one record.

2. A secure global model computation device in a federated learning system including M local model training devices for training local models using training data and a secure global model computation system composed of N secure global model computation devices for secure computation of a global model from M local models,
wherein M and K are integers of 2 or more and N is an integer of 3 or more, a local model is defined as a model represented using K vectors, and a local model management table is defined as a table including an attribute having a set (m, k) (1≤m≤M, 1≤k≤K) of an identifier m for identifying a local model and an identifier k for identifying a vector constituting the local model as an attribute value and an attribute having shares of parameters of the local model as an attribute value, the secure global model computation device comprising:
a transmission/reception circuitry configured to receive shares of parameters of a local model (hereinafter referred to as an m-th local model) trained by one local model training device (hereinafter referred to as an m-th local model training device (where m satisfies 1≤m≤M)) among the M local model training devices; and
a parameter share registration circuitry configured to register the shares of the parameters of the m-th local model in a local model management table using K records having a set (m, k) of identifiers and shares of parameters included in a k-th vector (1≤k≤K) of the m-th local model as one record.

3. A local model registration method,
wherein M and K are integers of 2 or more and N is an integer of 3 or more, a local model is defined as a neural network composed of K layers, and a local model management table is defined as a table including an attribute having a set (m, k) (1≤m≤M, 1≤k≤K) of an identifier m for identifying a local model and an identifier k for identifying a layer as an attribute value and an attribute having shares of parameters of the local model as an attribute value,
the local model registration method comprising:
a transmission/reception step in which a secure global model computation device in a federated learning system including M local model training devices for training local models using training data and a secure global model computation system composed of N secure global model computation devices for secure computation of a global model from M local models receives shares of parameters of a local model (hereinafter referred to as an m-th local model) trained by one local model training device (hereinafter referred to as an m-th local model training device (where m satisfies 1≤m≤M)) among the M local model training devices; and
a parameter share registration step in which the secure global model computation device registers the shares of the parameters of the m-th local model in a local model management table using K records having a set (m, k) of identifiers and shares of parameters of a k-th layer (1≤k≤K) of the m-th local model as one record.

4. A local model registration method,
wherein M and K are integers of 2 or more and Nis an integer of 3 or more, a local model is defined as a model represented using K vectors, and a local model management table is defined as a table including an attribute having a set (m, k) (1≤m≤M, 1≤k≤K) of an identifier m for identifying a local model and an identifier k for identifying a vector constituting the local model as an attribute value and an attribute having shares of parameters of the local model as an attribute value,
the local model registration method comprising:
a transmission/reception step in which a secure global model computation device in a federated learning system including M local model training devices for training local models using training data and a secure global model computation system composed of N secure global model computation devices for secure computation of a global model from M local models receives shares of parameters of a local model (hereinafter referred to as an m-th local model) trained by one local model training device (hereinafter referred to as an m-th local model training device (where m satisfies 1≤m≤M)) among the M local model training devices; and
a parameter share registration step in which the secure global model computation device registers the shares of the parameters of the m-th local model in a local model management table using K records having a set (m, k) of identifiers and shares of parameters included in a k-th vector (1<k≤K) of the m-th local model as one record.

5. A non-transitory computer-readable storage medium which stores a program for causing a computer to function as the secure global model computation device according to claim 1.

6. A non-transitory computer-readable storage medium which stores a program for causing a computer to function as the secure global model computation device according to claim 2.
